(19) United States
(12) Patent Application Publication
(10) Pub. No.: US 2018/0109465 A1
(43) Pub. Date: Apr. 19, 2018

(54) Methods and Systems for Determining and Using Characteristics of Network Carriers in Connection with Access Requests

(71) Applicant: FACEBOOK, INC., Menlo Park, CA (US)

(72) Inventors: Vincent Gonguet, San Francisco, CA (US); Yingyi Liang, San Mateo, CA (US); Luyang Zhang, Foster City, CA (US); Yan Ou, Menlo Park, CA (US); Andrew Daco Maganito, Fremont, CA (US); Fenghong Chen, Fremont, CA (US); Chia-Chi Lin, Menlo Park, CA (US)

(21) Appl. No.: 15/298,105

(22) Filed: Oct. 19, 2016

(51) Int. Cl. H04L 12/911; H04L 29/08; H04L 29/06

(52) U.S. Cl. CPC H04L 47/70; H04W 88/02; H04L 67/42; H04L 67/16

(57) ABSTRACT

A server system receives, from a first user device through a first network carrier, a request to access content. One or more characteristics of the first network carrier are determined from the request, including at least one of an identity of the first network carrier and a network type of the first network carrier. The determining includes performing a look-up using information from the request. Furthermore, the server system performs at least one of: (1) storing the determined one or more characteristics in association with the first user device in a first data structure, where the first data structure specifies, for multiple user devices, at least an identity of associated network carriers and a network type; and (2) providing access to requested content, which includes content customized based on the determined one or more characteristics.

### TECHNICAL FIELD

This relates generally to network communications, including but not limited to determining and using characteristics of network carriers in connection with access requests.

### BACKGROUND

The ability to accurately determine an identity and other characteristics of a network carrier through which access requests for web content are sent is important for many applications. Characteristics of a network carrier may be used, for example, to determine services, features, and content that should be made available to subscribers of the network carrier. This information is not made available to online service providers in many cases. Furthermore, even when it is available, the information provided may be outdated or altogether incorrect.

### SUMMARY

Accordingly, there is a need for methods and systems for determining and using characteristics of network carriers in connection with access requests. After receiving a request for access to content from a user device through a network carrier, one or more techniques are implemented to determine characteristics of the network carrier using various types of information from the request. Thereafter, one or more operations may be performed using the determined characteristics of the network carrier, such as providing access to the requested content, including content that is customized based on the determined characteristics of the network carrier. By doing so, systems are able to effectively and efficiently provide users access to requested content.

In accordance with some embodiments, a method is performed at a server system having one or more processors and memory storing instructions for execution by the one or more processors. The method includes receiving, from a first user device through a first network carrier, a request to access content. One or more characteristics of the first network carrier are determined from the request, including at least one of an identity of the first network carrier and a network type of the first network carrier. The determining includes performing a look-up using information from the request. Furthermore, the server system performs at least one of: (1) storing the determined one or more characteristics of the first network carrier in association with the first user device in a first data structure, the first data structure specifying, for a plurality of user devices including the first user device, at least one of an identity of an associated network carrier and a network type of the associated network carrier; and (2) providing access to the requested content, wherein the requested content includes content that is customized based on the determined one or more characteristics of the first network carrier.

In accordance with some embodiments, a server system includes one or more processors, memory, and one or more programs; the one or more programs are stored in the memory and configured to be executed by the one or more processors. The one or more programs include instructions for performing the operations of the method described above. In accordance with some embodiments, a non-transitory computer-readable storage medium has stored therein instructions that, when executed by the server system, cause the server system to perform the operations of the method described above.

Thus, server systems are provided with more effective and efficient methods for providing users access to requested content, thereby increasing the effectiveness and efficiency of such systems and user satisfaction in connection with the systems.

### BRIEF DESCRIPTION OF THE DRAWINGS

For a better understanding of the various described embodiments, reference should be made to the Description of Embodiments below, in conjunction with the following drawings. Like reference numerals refer to corresponding parts throughout the figures and description.

FIG. 1 is a block diagram illustrating an exemplary network architecture, in accordance with some embodiments.

FIG. 2 is a block diagram illustrating an exemplary user device, in accordance with some embodiments.

FIG. 3 is a block diagram illustrating an exemplary server system, in accordance with some embodiments.

FIG. 4 illustrates an exemplary data structure storing information for user devices and associated network carriers in connection with access requests, in accordance with some embodiments.

FIGS. 5A-5C are flow diagrams illustrating a method of identifying and using access rules for network carriers to grant or deny access to content in accordance with eligible pricing policies, in accordance with some embodiments.

### DESCRIPTION OF EMBODIMENTS

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first network carrier could be termed a second network carrier, and, similarly, a second network carrier could be termed a first network carrier, without departing from the scope of the various described embodiments. The first network carrier and the second network carrier are both network carriers, but they are not the same network carrier.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

As used herein, the term “exemplary” is used in the sense of “serving as an example, instance, or illustration” and not in the sense of “representing the best of its kind.”

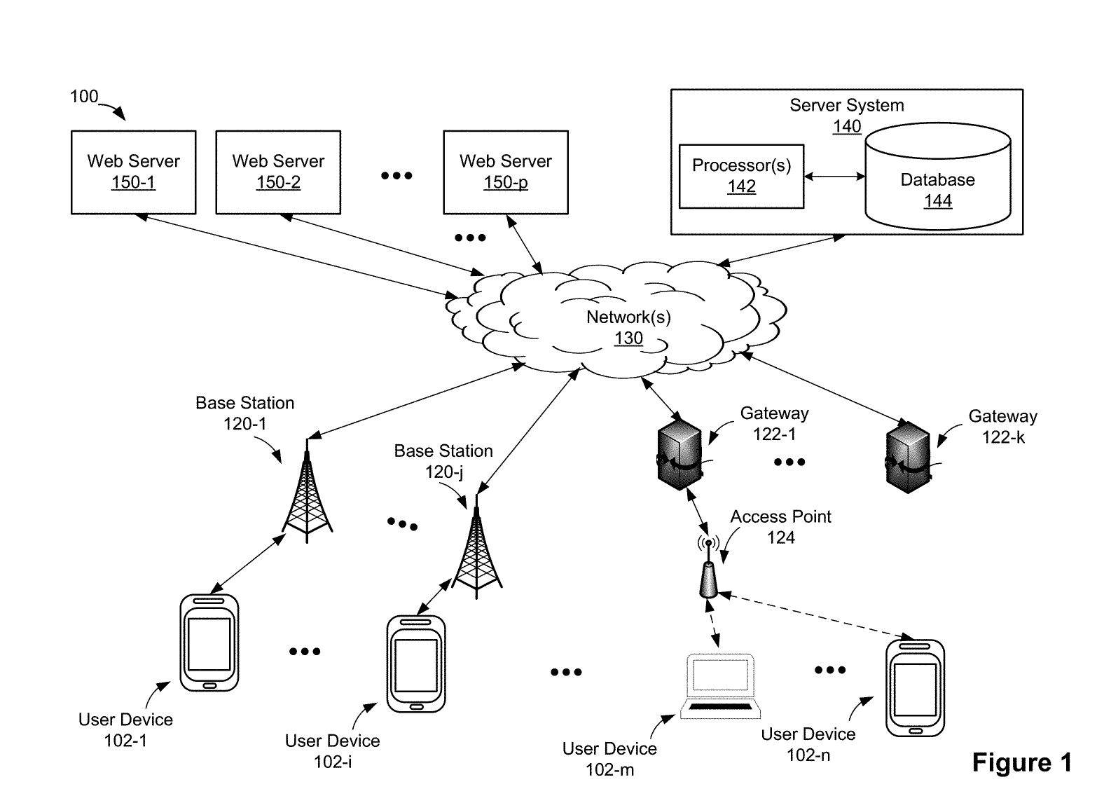

FIG. 1 is a block diagram illustrating an exemplary network architecture 100 in accordance with some implementations. The network architecture 100 includes one or more user devices 102-1 . . . 102-n (where n is an integer greater than or equal to one), one or more server systems 140, and optionally one or more web servers 150-1 . . . 150-p. One or more networks 130 communicably connect each component of the network architecture 100 with other components of the network architecture 100. In some implementations, the one or more networks 130 include public communication networks, private communication networks, or a combination of both public and private communication networks. For example, the one or more networks 130 can be any network (or combination of networks) such as the Internet, other wide area networks (WAN), local area networks (LAN), virtual private networks (VPN), metropolitan area networks (MAN), peer-to-peer networks, and/or ad-hoc connections.

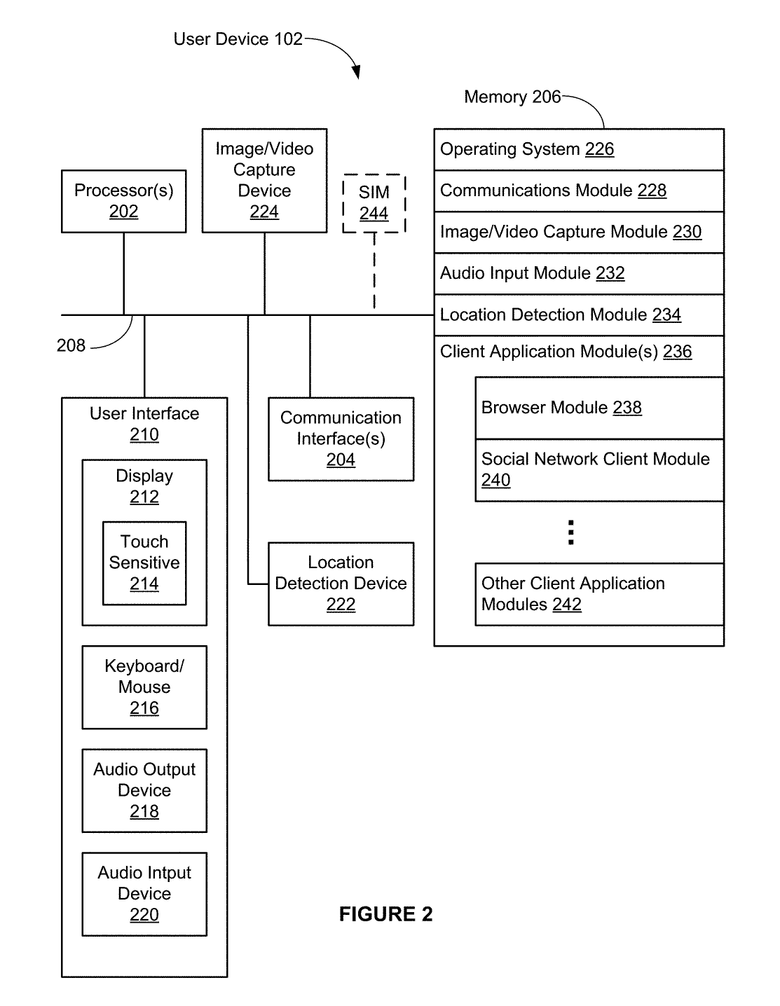

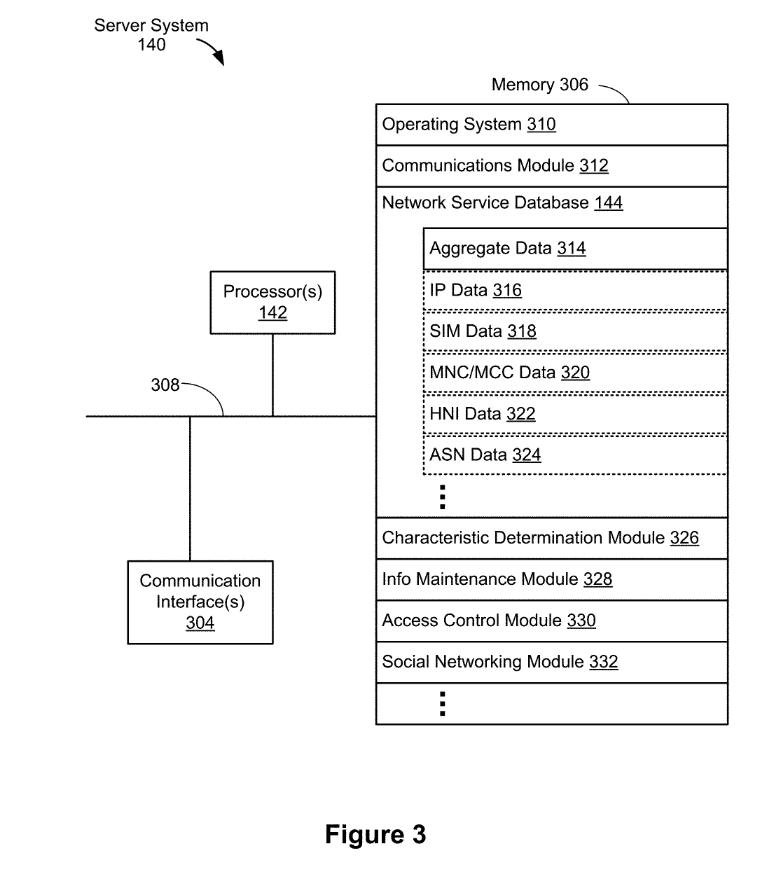

The network architecture 100 includes client-side modules (e.g., as discussed with reference to FIG. 2) executed on a number of user devices (also called “client devices,” “client systems,” “client computers,” “subscriber devices,” or “clients”) 102-1 . . . 102-i . . . 102-m . . . 102-n and server-side modules (e.g., as discussed with reference to FIG. 3) executed on one or more server systems, such as a server system 140 and/or one or more web servers 150-1, 150-2 . . . 150-p. The user devices 102 communicate with the server systems (e.g., the server system 140 and/or the one or more web servers 150) through one or more networks 130 (e.g., the Internet, cellular telephone networks, mobile data networks, other wide area networks, local area networks, metropolitan area networks, and so on). Client-side modules provide client-side functionalities for accessing the network service platform (e.g., services provided by server systems 140, web servers 150, etc.). Server-side modules provide server-side functionalities for the network service platform (e.g., providing access to content that is customized based on determined characteristics of network carriers) for any number of user devices 102.

In some embodiments, the user devices 102 are mobile devices and/or fixed-location devices. The user devices 102 are associated with users or subscribers (not shown) who employ the user devices 102 to participate in or access online services or features (e.g., provided by server systems 140, web servers 150, etc.). For example, one or more of the user devices 102-1, 102-2, . . . 102-n execute web browser applications (e.g., browser module 238, FIG. 2) and/or other applications that can be used to access a service hosted by the server system 140 and/or a web server 150. One or more of the user devices 102-1, 102-2, . . . 102-n may execute software applications that are specific to a service provided by a server system 140 and/or web server 150 (e.g., social-networking “apps,” such as social network client module 240 in FIG. 2, running on smart phones or tablets, such as a Facebook social-networking application running on an iPhone, Android, or Windows smart phone or tablet, used for accessing a social-networking service provided by server system 140). In some embodiments, a user device 102 processes requests for network services and forwards the requests from the user device 102 to the server system 140 (e.g., via a network carrier). The requests for network services include, but are not limited to, one or more Domain Name System (DNS) requests and one or more Transmission Control Protocol (TCP) requests.

Examples of the user devices 102 include, but are not limited to, feature phones, smart phones, smart watches, personal digital assistants, portable media players, tablet computers, 2D gaming devices, 3D (e.g., virtual reality) gaming devices, laptop computers, desktop computers, televisions with one or more processors embedded therein or coupled thereto, in-vehicle information systems (e.g., an in-car computer system that provides navigation, entertainment, and/or other information), wearable computing devices, personal digital assistants (PDAs), enhanced general packet radio service (EGPRS) mobile phones, media players, navigation devices, game consoles, smart televisions, remote controls, combinations of any two or more of these data processing devices or other data processing devices, and/or other appropriate computing devices that can be used to communicate with network systems (e.g., server system 140, web servers 150, etc.).

In some embodiments, the network architecture 100 includes one or more base stations 120-1 . . . 120-j for carrier networks that provide cellular/wireless service to the user devices 102. One or more network operators (e.g., network service providers, network carriers, or cellular companies) own or control the one or more base stations 120 and related infrastructure. For example, the base station 120 communicably connects one or more user devices 102 (e.g., 102-1) to one another (e.g., 102-i) and/or to the networks 130. In some embodiments, the network architecture 100 includes one or more gateways 122-1 . . . 122-k connected to one or more wireless access points 124-1 . . . 124-q respectively for providing Wi-Fi networks to the user devices 102 (e.g., 102-m, 102-n). In some embodiments, the one or more gateways 122-1 . . . 122-k are associated with one or more network operators (e.g., network service providers, network carriers, etc.) who provide access to the network service platform (e.g., online services or features provided by server systems 140, web servers 150, etc.). The base stations 120 and the gateways 122 are responsible for routing traffic between the networks 130 and the user device 102.

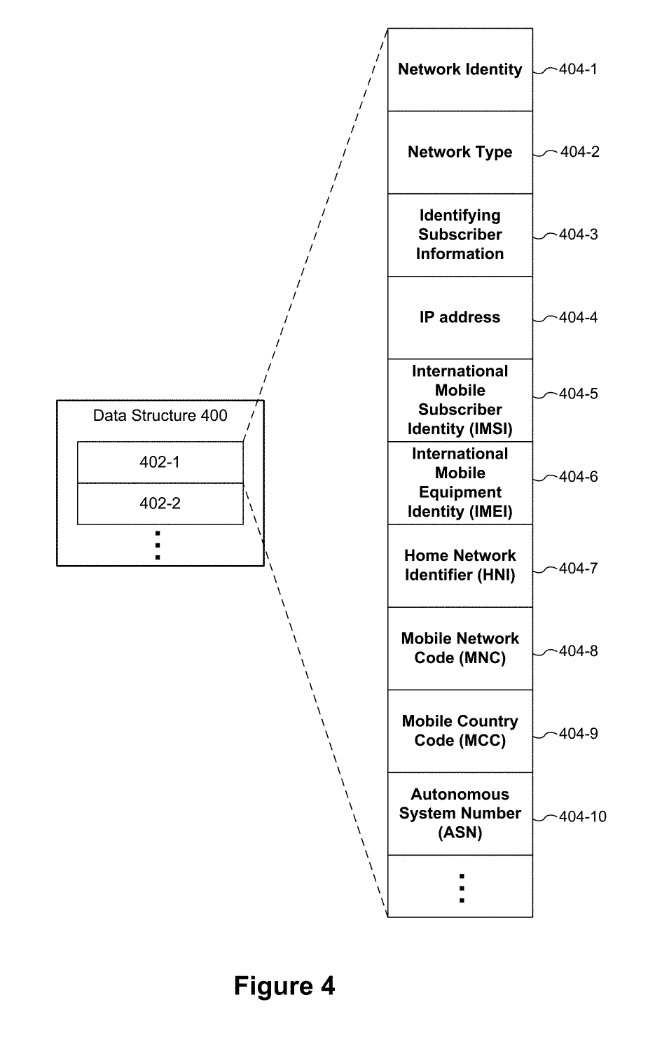

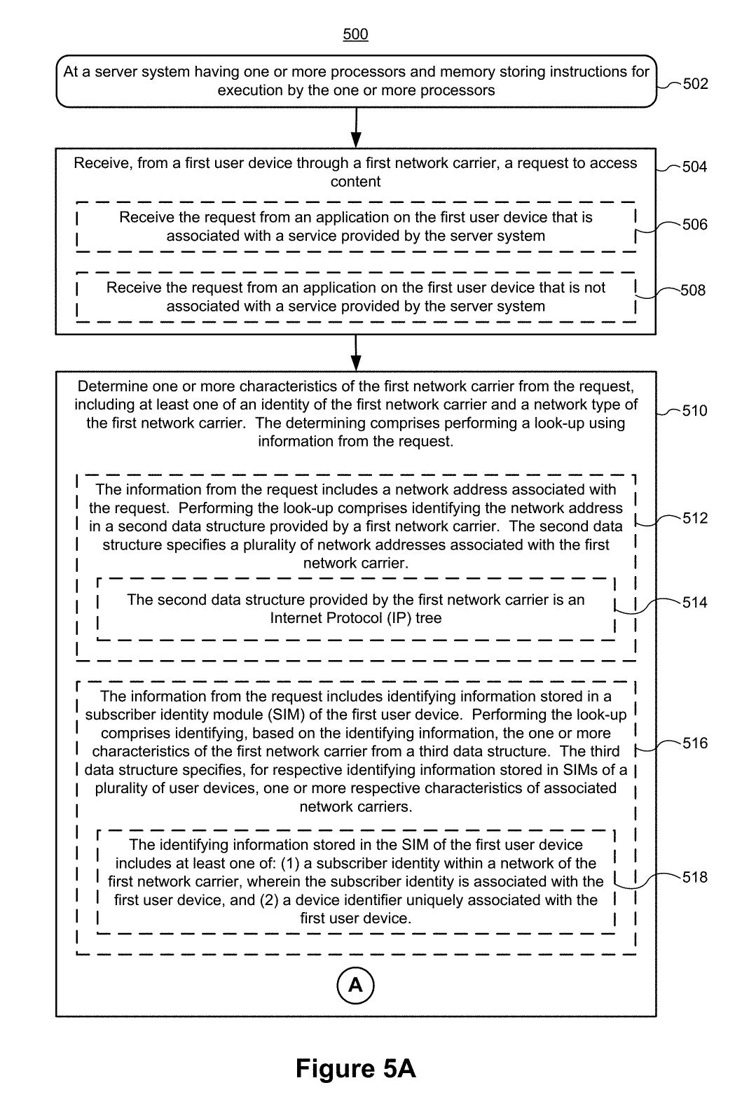

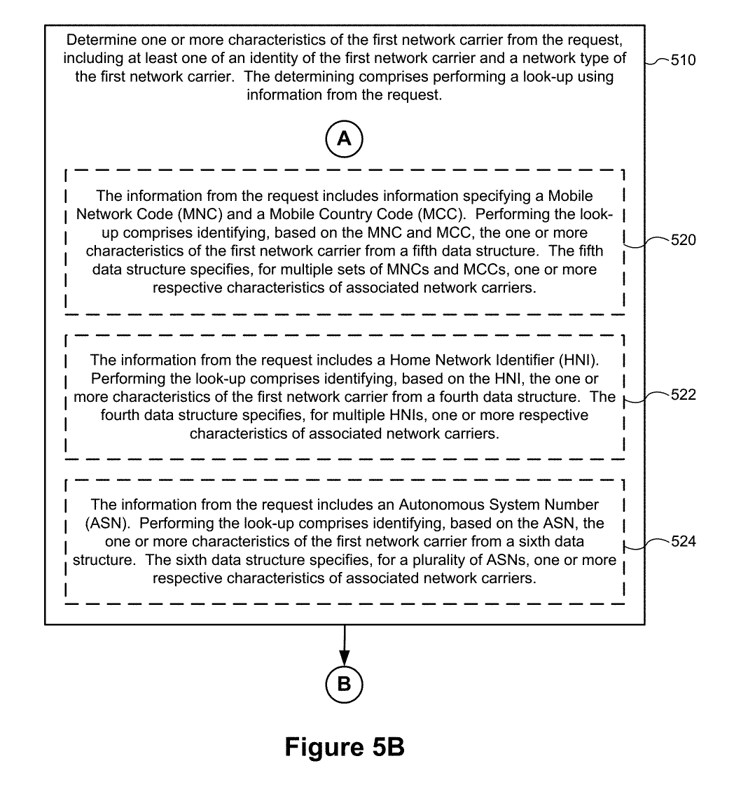

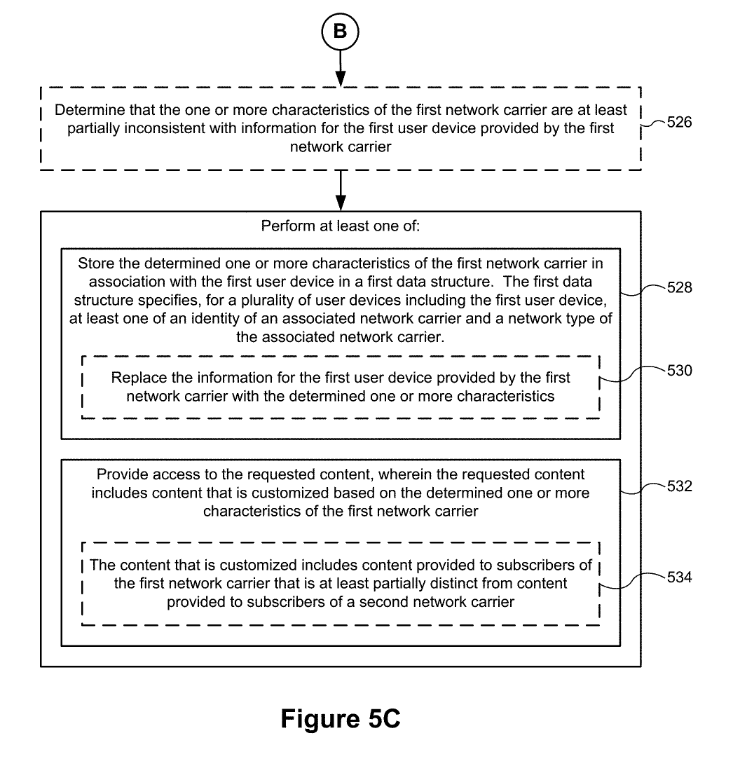

In some embodiments, the server system 140 is implemented on one or more standalone computers or a distributed network of computers. In some embodiments, the server system 140 also employs various virtual devices and/or services of third party service providers (e.g., cloud computing) to provide the underlying computing resources and/or infrastructure resources of the server system 140. The server system 140 includes one or more processing units (e.g., processors 142 or cores) and one or more databases 144. The database 144 stores various information, including but not limited to one or more data structures (e.g., tables, databases, etc.) that store any combination of network carrier characteristics (e.g., network carrier identity, network type, etc.) and identifying information (e.g., IP addresses, International Mobile Subscriber Identities (IMSIs), etc.) for user devices and/or associated network subscribers (e.g., user devices/subscribers who request access to online services, features, and/or content provided by server systems 140, web servers 150, etc.). Various data structures used and the information they store are described in greater detail with respect to FIGS. 4 and 5A-5C.

Characteristics of network carriers through which requests to access content are received may determine the content, features, and/or services that are provided to or accessible by the user devices 102 that send the access requests. For example, a user device 102-1 requesting access to content via a first network carrier (e.g., through base station 120-1) may be provided with a first set of advertisements that is distinct from a second set of advertisements provided to a different user device 102-1 requesting access to content via a second network carrier (e.g., through base station 120-2). Therefore, in some embodiments, a server system 140 receives, from a user device (e.g., 102-1) through a network carrier (e.g., through base station 120-1), a request to access content. The server system 140 determines one or more characteristics of the network carrier from the request, such as an identity (e.g., name) and a network type of the network carrier (e.g., a cellular standard associated with the network carrier infrastructure, such as GSM, CDMA, etc.). Determining these characteristics may include performing one or more characteristic-determination techniques, such as performing a look-up (e.g., in one or more databases 144) using information from the request (e.g., IP address or other device/subscriber information included in the request). The server system 140 may then perform one or more actions, such as storing the determined characteristics of the network carrier in association with the user device in a data structure (e.g., aggregate data structure 314, FIG. 2), and/or providing access to the requested content, including content that is customized based on the determined characteristics of the network carrier (e.g., providing features/services that may be accessible only to subscribers of the network carrier). Various characteristic-determination techniques are described in greater detail throughout.

In some embodiments, the one or more web servers 150-1, 150-2 . . . 150-p (and/or one or more server systems 140) include social networking servers configured to host various social networking functionalities. In some embodiments, the one or more web servers 150-1, 150-2 . . . 150-p include third-party servers configured to provide other types of third-party services or content. Exemplary third-party services include books, business, communication (e.g., text/video messaging applications), contests, education, entertainment, fashion, finance, food and drink, games, health and fitness, lifestyle, local information, movies, television, music and audio, news, photos, video, productivity, reference material, security, shopping, sports, travel, utilities, social networking (e.g., applications for accessing a social network service), and the like.

In some embodiments, a given web server 150 hosts a web site that provides web pages to user devices 102. Alternatively or additionally, a given web server 150 hosts an application that is used by user devices 102. In some embodiments, the server system 140 may route or redirect requests from user devices 102 to respective web servers 150 (e.g., based on determined characteristics of a network carrier through which an access request is received). In some embodiments, the server system 140 uses inline frames (“iframes”) to nest independent websites within a web page. In some embodiments, the server system 140 uses iframes to enable third-party developers to create applications that are hosted separately by a web server 150 (e.g., a third-party server), but operate within a user session and are accessed through the user's profile in the server system 140. In some embodiments, a given web server 150 is a single computing device, while in other embodiments, a given web server 150 is implemented by multiple computing devices working together to perform the actions of a server system (e.g., cloud computing).

FIG. 2 is a block diagram illustrating an exemplary user device 102 in accordance with some embodiments. The user device 102 typically includes one or more processing units (processors or cores) 202, one or more network or other communications interfaces 204, memory 206, and one or more communication buses 208 for interconnecting these components. The communication buses 208 optionally include circuitry (sometimes called a chipset) that interconnects and controls communications between system components. The user device 102 includes a user interface 210. The user interface 210 typically includes a display device 212. In some embodiments, the user device 102 includes inputs such as a keyboard, mouse, and/or other input buttons 216. Alternatively or in addition, in some embodiments, the display device 212 includes a touch-sensitive surface 214, in which case the display device 212 is a touch-sensitive display. In client devices that have a touch-sensitive display 212, a physical keyboard is optional (e.g., a soft keyboard may be displayed when keyboard entry is needed). The user interface 210 also includes an audio output device 218, such as speakers or an audio output connection connected to speakers, earphones, or headphones. Furthermore, some client devices 102 use a microphone and voice recognition to supplement or replace the keyboard. Optionally, the user device 102 includes an audio input device 220 (e.g., a microphone) to capture audio (e.g., speech from a user). Optionally, the user device 102 includes a location detection device 222, such as a GPS (global positioning satellite) or other geo-location receiver, for determining the location of the user device 102. The user device 102 also optionally includes an image/video capture device 224, such as a camera or webcam.

Memory 206 includes high-speed random-access memory, such as DRAM, SRAM, DDR RAM or other random-access solid-state memory devices; and may include non-volatile memory, such as one or more magnetic disk storage devices, optical disk storage devices, flash memory devices, or other non-volatile solid-state storage devices. Memory 206 may optionally include one or more storage devices remotely located from the processor(s) 202. Memory 206, or alternately the non-volatile memory device(s) within memory 206, includes a non-transitory computer-readable storage medium. In some embodiments, memory 206 or the computer-readable storage medium of memory 206 stores the following programs, modules and data structures, or a subset or superset thereof:
an operating system 226 that includes procedures for handling various basic system services and for performing hardware dependent tasks;
a network communication module 228 that is used for connecting the user device 102 to other computers via the one or more communication network interfaces 204 (wired or wireless) and one or more communication networks, such as the Internet, cellular telephone networks, mobile data networks, other wide area networks, local area networks, metropolitan area networks, and so on;
an image/video capture module 230 (e.g., a camera module) for processing a respective image or video captured by the image/video capture device 224;
an audio input module 232 (e.g., a microphone module) for processing audio captured by the audio input device 220;
a location detection module 234 (e.g., a GPS, Wi-Fi, or hybrid positioning module) for determining the location of the user device 102 (e.g., using the location detection device 222) and providing this location information for use in various applications (e.g., social network client module 240); and
one or more client application modules 236, including the following modules (or sets of instructions), or a subset or superset thereof:
   a web browser module 238 (e.g., Edge or Internet Explorer by Microsoft, Firefox or Nightly by Mozilla, Safari by Apple, or Chrome by Google) for accessing, viewing, and interacting with web sites (e.g., accessing features, services, or content provided by a web server 150-1, FIG. 1),
   a social network module 240 for providing an interface for accessing content and related features provided by a social-networking service (e.g., a social-networking service provided by a server system 140); and/or
   other optional client application modules 242, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

In some embodiments, memory 206 (or modules thereof), subscriber identity module (SIM) 244, and/or other components of the user device 102 (not shown), store (and optionally maintain) information associated with the user device 102 and/or subscribers of a network service platform (e.g., web service provided by a network carrier in network architecture 100) who use the user device 102. Information may include identifying information for the user devices (e.g., IP address, IMSI, IMEI, etc.) and/or subscribers, and optionally characteristics of network carriers through which network services or content is accessed (e.g., identity of network carrier, network type, etc.).

FIG. 3 is a block diagram illustrating an exemplary server system 140 in accordance with some embodiments. The server system 140 includes one or more processing units (processors or cores) 142, one or more network or other communications interfaces 304, memory 306, and one or more communication buses 308 for interconnecting these components. The communication buses 308 optionally include circuitry (sometimes called a chipset) that interconnects and controls communications between system components. The server system 140 optionally includes a user interface (not shown). The user interface, if provided, may include a display device and optionally includes inputs such as a keyboard, mouse, trackpad, and/or input buttons. Alternatively or in addition, the display device includes a touch-sensitive surface, in which case the display is a touch-sensitive display.

Memory 306 includes high-speed random-access memory, such as DRAM, SRAM, DDR RAM, or other random-access solid-state memory devices; and may include non-volatile memory, such as one or more magnetic disk storage devices, optical disk storage devices, flash memory devices, and/or other non-volatile solid-state storage devices. Memory 306 may optionally include one or more storage devices remotely located from the processor(s) 142. Memory 306, or alternately the non-volatile memory device(s) within memory 306, includes a non-transitory computer-readable storage medium. In some embodiments, memory 306 or the computer-readable storage medium of memory 306 stores the following programs, modules and data structures, or a subset or superset thereof:
an operating system 310 that includes procedures for handling various basic system services and for performing hardware dependent tasks;
a network communication module 312 that is used for connecting the server system 140 to other computers via the one or more communication network interfaces 304 (wired or wireless) and one or more communication networks (e.g., the one or more networks 130);
a network service database 144 storing data (in one or more data structures) for user devices and associated network carriers in connection with access requests (e.g., identifying information from the request, determined characteristics of network carriers, etc.), which includes:
   an aggregate data structure 314 storing aggregated information (e.g., identifying information for user devices 102 and/or subscribers, characteristics of network carriers, etc.) obtained during or determined from the performance of one or more characteristic-determination techniques (e.g., using a network address, IMSI, HNI, etc. to perform a look-up);
   an optional Internet Protocol (IP) data structure 316 storing network addresses (e.g., IP addresses) associated with one or more network carriers;
   an optional Subscriber Identity Module (SIM) data structure 318 storing identifying information that is stored in SIMs of user devices (e.g., IMSI, IMEI, etc.), and characteristics of associated network carriers (e.g., network identity, network type, etc.);
   an optional Mobile Network Code (MNC)/Mobile Country Code (MCC) data structure 320 storing MNCs and/or MCCs, and characteristics of associated network carriers (e.g., network identity, network type, etc.);
   an optional Home Network Identifier (HNI) data structure 322 storing HNIs and characteristics of associated network carriers (e.g., network identity, network type, etc.); and
   an optional Autonomous System Number (ASN) data structure 324 storing ASNs and characteristics of associated network carriers (e.g., network identity, network type, etc.);
characteristic determination module 326 for determining characteristics (e.g., network identity, network type, etc.) of network carriers through which access requests are received (e.g., performing look-ups in network service database 144 using information from the requests);
information maintenance module 328 for maintaining information associated with access requests received from devices (e.g., updating one or more data structures of database 144 with identifying information for user devices 102 and/or subscribers, determined characteristics of network carriers, etc.);
an access control module 330 for handling and responding to requests by user devices 102, for granting or denying access to requested content, and for identifying customized content to provide access to (e.g., based on determined characteristics of a network carrier through which a request is received); and
   a social networking module 322 for providing social-networking services and related features.

Each of the above identified modules and applications correspond to a set of executable instructions for performing one or more functions as described above and/or in the methods described in this application (e.g., the computer-implemented methods and other information processing methods described herein). These modules (i.e., sets of instructions) need not be implemented as separate software programs, procedures or modules, and thus various subsets of these modules are, optionally, combined or otherwise re-arranged in various embodiments. In some embodiments, memory 206 and/or 306 store a subset of the modules and data structures identified above. Furthermore, memory 206 and/or 306 optionally store additional modules and data structures not described above.

FIG. 4 illustrates an exemplary data structure storing information for user devices and associated network carriers in connection with access requests, in accordance with some embodiments. In particular, FIG. 4 illustrates an exemplary data structure 400 stored in memory 306 of server system 140 (e.g., aggregate data structure 314, IP data structure 316, SIM data structure 318, etc.). Data structure 400 includes a plurality of entries (e.g., 402-1, 402-2, . . . ), each of which includes one or a plurality of fields (e.g., 404-1, 404-2, . . . ).

Although FIG. 4 illustrates a single data structure, in some embodiments, one or more additional data structures are stored in and maintained by server system 140 (and/or other server systems). Additional data structures may include a plurality of entries, each of which includes one or a combination of fields (e.g., 404-1, 404-2, . . . ). For example, in some embodiments, optional IP data structure 316 (FIG. 3) includes entries specifying IP addresses 404-4 for subscribers of a network carrier.

Some of the additional data structures may be provided (e.g., separately created and/or maintained) by network entities distinct from the server system 140 (e.g., provided by network carriers, third-party servers, etc.). As an example, a network carrier may provide server system 140 with a data structure that specifies identifying information (e.g., IP addresses) for devices of subscribers of the network carrier.

In some embodiments, multiple data structures (e.g., stored in and maintained by server system 140) may include entries that specify one or more of the same fields (e.g., a first data structure includes entries that map device IP addresses and IMSIs, and a second data structure includes entries that map device IP addresses and HNIs). In some embodiments, multiple entries of a data structure may specify the same information with respect to one or more fields (e.g., a particular IP address is associated with multiple network carriers).

In some embodiments, entries of a data structure (e.g., data structure 400) may include some information that is obtained from (e.g., included with or derived from) requests for access received from user devices, and other information that is obtained separately from the requests for access (e.g., provided by a third-party, such as network carriers, third-party servers, etc.).

As shown in FIG. 4, entries 402 of the data structure 400 include fields 404 that specify information associated with user devices and/or subscribers of a network service platform (e.g., user device 102 of network architecture 100 who requests access to content provided by server systems 140, web servers 150, etc., FIG. 1). Information may include identifying information for the user devices and/or subscribers, and associated characteristics of network carriers through which content access requests are transmitted by the user devices (e.g., network carriers who are associated with and/or operate base stations 120, FIG. 1). Information includes, but is not limited to: network identity 404-1 (e.g., organization name or other identifier of a network carrier), network type 404-2 (e.g., cellular standard associated with the network carrier, such as GSM, CDMA, etc.), identifying subscriber information 404-3 (e.g., username, login ID, e-mail address, and/or other user credentials; subscription information for a user device 102/subscriber that determines accessible services, features, content, content types, etc.), Internet Protocol (IP) address 404-4 (public and/or private), International Mobile Subscriber Identity (IMSI) 404-5, International Mobile Equipment Identity (IMEI) 404-6, Home Network Identifier (HNI) 404-7, Mobile Network Code (MNC) 404-8, Mobile Country Code (MCC) 404-9, and/or Autonomous System Number (ASN) 404-10.

Data structure 400 (and/or one or more other data structures) may also specify other network carrier characteristics, such as an operation type (e.g., a mobile network operator (MNO) who is a network carrier that has at least part ownership of a network infrastructure through which access requests are sent and content is provided, or a mobile virtual network operator (MVNO)/mobile other licensed operator (MOLO) who is a network carrier that does not own, but obtains access to network infrastructure that is owned and operated by another network carrier), or region(s) of operation (e.g., countries, states, cities, and/or other pre-defined geographic regions in which a network carrier provides service to subscribers). Data structure 400 (and/or one or more other data structures) may also specify other identifying device or subscriber information (e.g., MAC addresses, geographic location information, etc.).

As described throughout, any of the information described above (e.g., identifying information for the user devices/subscribers, associated characteristics of network carriers, etc.) may be stored in one or more components of user devices 102 (e.g., memory 206, SIM 244, etc.). In some implementations, some information may be stored in a component (or a set of components) of a user device 102, but not stored in any other components (e.g., International Mobile Subscriber Identity (IMSI) information is stored in SIM 244 of user device 102, but not in other modules of memory 206, FIG. 2). Stated another way, in some implementations, some components of a user device 102 may be permitted to store only certain types of information.

Furthermore, any of the information described above may be sent (and/or accessed) by one or more modules of user devices 102 (e.g., application modules, such as browser module 238, social network client module 240, etc. . . . to one or more systems or devices in the network 100, such as server system 140, FIG. 1). In some implementations, some information may be sent (and/or accessed) by a module (or set of modules) of a user device 102, but not sent by any other modules. In other words, in some implementations, only some (i.e., not all) application modules of a user device 102 are permitted to access and/or transmit certain types of information. For example, information stored on SIM 244 of user device 102 (FIG. 2) (e.g., IMSI, IMEI, and/or HNI information) may be accessed and sent by an application module associated with a service provided by the server system 140 (e.g., social network client module 240), but not by other application modules (e.g., browser module 238). As another example, ASN information may be accessed and sent by a web browser (e.g., browser module 238), but not by other application modules (e.g., social network client module 240).

FIGS. 5A-5C are flow diagrams illustrating method 500 of determining and using characteristics of network carriers in connection with access requests, in accordance with some embodiments. The method 500 is performed (502) at a server system (e.g., server system 140, FIG. 3) having one or more processing units (e.g., processors or cores) and memory storing instructions for execution by the one or more processors. FIGS. 5A-5C correspond to instructions stored in a computer memory (e.g., memory 306 of the server system 140, FIG. 3) or other computer-readable storage medium.

In performing the method 500, the server system receives (504), from a first user device through a first network carrier (or an associated system of, or a system operated by, the first network carrier), a request to access content. Referring to FIG. 1, for example, server system 140 receives from user device 102-1 via base station 120-1 a request to access content, where base station 120-1 is operated by a first network carrier.

In some embodiments, the request is received (506) from an application on the first user device that is associated with a service provided by the server system (e.g., access request received from social network client module 240 of user device 102, where the module 240 is associated with and/or used to access services, features, and/or content provided by the server system 140, FIG. 2). In some embodiments, the request is received (508) from an application on the first user device that is not associated with a service provided by the server system (e.g., an application module for accessing content, such as web browser module 238, FIG. 2).

One or more characteristics of the first network carrier are determined (510) from the request, including at least one of an identity of the first network carrier (e.g., name of network carrier) and a network type of the first network carrier (e.g., cellular standard associated with the network carrier infrastructure) (other exemplary characteristics of network carriers are described with respect to FIG. 4). The determining comprises performing a look-up using information from the request. As described in detail below, the one or more characteristics may be determined by implementing one or multiple characteristic-determination techniques (e.g., using various types of information to perform look-ups). Determined characteristics may then be used to perform one or more operations, such as providing content that is customized based on the characteristics (various operations are described in greater detail with respect to FIG. 5C).

In some embodiments, the information from the request used for performing the look-up is included (and transmitted) with the request. The information from the request used may be contained within a header of the request (e.g., header includes IP address information associated with request). Additionally and/or alternatively, the information from the request is separate from the request, and may be transmitted by the first user device with or separately from the request.

In some embodiments, the information from the request includes (512) a network address (e.g., public IP address of user device 102) associated with the request. Performing the look-up comprises identifying the network address in a second data structure provided by a first network carrier. The second data structure specifies a plurality of network addresses associated with the first network carrier (e.g., IP data structure 316, aggregate data structure 314, or any other optional data structures described with respect to FIGS. 3 and 4). In some embodiments, the second data structure provided by the first network carrier is (514) an Internet Protocol (IP) tree.

In some embodiments, the information from the request includes (516) identifying information stored in a subscriber identity module (SIM) of the first user device (e.g., SIM 244, FIG. 2). Performing the look-up comprises identifying, based on the identifying information, the one or more characteristics of the first network carrier from a third data structure. The third data structure specifies, for respective identifying information stored in SIMs of a plurality of user devices, one or more respective characteristics of associated network carriers (e.g., SIM data structure 318, aggregate data structure 314, or any other optional data structures described with respect to FIGS. 3 and 4). In some embodiments, the identifying information stored in the SIM of the first user device includes (518) at least one of: (1) a subscriber identity within a network of the first network carrier, wherein the subscriber identity is associated with the first user device (e.g., International Mobile Subscriber Identity (IMSI), which defines a country and network carrier with which a subscriber of a user device is associated), and (2) a device identifier uniquely associated with the first user device (e.g., International Mobile Equipment Identity (IMEI)).

Referring now to FIG. 5B, in some embodiments, the information from the request includes (520) information specifying a Mobile Network Code (MNC) and a Mobile Country Code (MCC). Performing the look-up comprises identifying, based on the MNC and MCC, the one or more characteristics of the first network carrier from a fifth data structure. The fifth data structure specifies, for multiple sets of MNCs and MCCs, one or more respective characteristics of associated network carriers (e.g., MNC/MCC data structure 320, aggregate data structure 314, or any other optional data structures described with respect to FIGS. 3 and 4). In some embodiments, the combination of an MCC and an MNC uniquely identifies a mobile network carrier (e.g., using certain cellular network technology, such as GSM, UMTS, LTE public land mobile networks, CDMA, etc.).

In some embodiments, the information from the request includes (522) a Home Network Identifier (HNI). Performing the look-up comprises identifying, based on the HNI, the one or more characteristics of the first network carrier from a fourth data structure. The fourth data structure specifies, for multiple HNIs, one or more respective characteristics of associated network carriers (e.g., HNI data structure 322, aggregate data structure 314, or any other optional data structures described with respect to FIGS. 3 and 4). In some embodiments, an HNI includes both a Mobile Network Code (MNC) and a Mobile Country Code (MCC).

In some embodiments, identifying (522) the one or more characteristics based on the HNI includes identifying a group of IP addresses associated with a plurality of HNIs including the HNI of the request, and determining from the fourth data structure that a threshold number of the plurality of HNIs of the group of IP addresses has the same one or more determined characteristics of the first network carrier. For example, if at least a predefined percentage or number of HNIs for a group of IP addresses is associated with a first set of characteristics (i.e., one or more characteristics) of a network carrier (e.g., network carrier identity, network type), the server system determines that one or more characteristics of a network carrier through which an access request is received are the same as the first set of characteristics, if the access request includes an HNI of the same group of IP addresses. In some embodiments, the server system determines if the access request originates from a first network carrier by checking (i.e., comparing) an IP address of the access request against a group of IP addresses associated with the HNI of the carrier.

In some embodiments, the information from the request includes (524) an Autonomous System Number (ASN) (private and/or public). Performing the look-up comprises identifying, based on the ASN, the one or more characteristics of the first network carrier from a sixth data structure. The sixth data structure specifies, for a plurality of ASNs, one or more respective characteristics of associated network carriers (e.g., ASN data structure 324, aggregate data structure 314, or any other optional data structures described with respect to FIGS. 3 and 4). In some embodiments, an autonomous system (AS) comprises a group of IP networks operated by one or more network carriers or operators. In some embodiments, an ASN is a globally unique number associated with a public AS. The ASN may be used in exchanging exterior routing information (e.g., between neighboring Autonomous Systems) and also as an identifier of the AS.

In some cases, information from the request (e.g., an IMEI) may be associated with characteristics of different network carriers. This may be the case, for example, when a device is used to access content through different network carriers under different subscription plans. In these cases, it may be necessary to determine which network carrier characteristics should be associated with an incoming access request. In some embodiments, the request (received in step 504, FIG. 5A) to access content is a current request. Furthermore, determining (step 510, FIGS. 5A-5B) the one or more characteristics of the first network carrier includes determining that the information from the request is further associated with one or more characteristics of a second network carrier (e.g., a first IMEI is associated with both a first network carrier that is a mobile network operator (MNO), and a second network carrier that is a mobile virtual network operator (MVNO)). A determination is made that one or more previous requests to access content received from the first user device through the first network carrier satisfy a threshold (e.g., the one or more previous requests were received within a threshold period of time before receiving the current request, the one or more previous requests includes more than a threshold number of previous requests, etc.). In response to determining that the one or more previous requests satisfy the predefined threshold, the server system associates the current request to access content with the one or more characteristics of the first network carrier (e.g., for an IMEI, if a threshold number of previous requests is associated with a first network carrier, then a current request that includes the same IMEI is associated with the characteristics of the first network carrier, rather than the second network carrier).

In some embodiments, determining (step 510) the one or more characteristics comprises implementing a plurality of characteristic-determination techniques, including performing a respective look-up using information from the request for each of the plurality of techniques. For example, each of the embodiments described above with respect to determining (step 510) the one or more characteristics comprises a characteristic-determination technique that uses respective information from the request to perform a respective look-up (e.g., steps 510 through 524, FIGS. 5A-5B). In these implementations, storing (step 528, described in detail with respect to FIG. 5C) the determined one or more characteristics comprises associating the first user device with: the respective information used to implement each of the plurality of techniques (e.g., using a network address to perform the look-up in step 512, using identifying information stored in a SIM to perform the look-up in step 516, and storing the network address, the identifying information stored in the SIM, and any determined network carrier characteristics in an entry of aggregate data structure 314 in association with the requesting user device). Thus, in some implementations, the first data structure (e.g., aggregate data structure 314 in FIG. 3, or any other data structures maintained by the server system 140) includes aggregate information associated with user devices (e.g., IP addresses, IMSIs, IMEIs, etc.) and network carrier(s) (e.g., network carrier identity, network type, etc.) through which requests for access are sent by the user devices.

In some embodiments, each of the plurality of characteristic-determination techniques has a respective ranking (e.g., a ranking selected from a predefined range of rankings), and implementing the plurality of techniques is performed in accordance with the rankings (e.g., respective rankings of characteristic-determination techniques define an order in which the plurality of characteristic-determination techniques are performed).

Sometimes, certain characteristic-determination techniques (e.g., designated techniques, techniques having lower than a threshold ranking, etc.) are performed only if characteristics of a network carrier are not adequately determined by implementing one or more other techniques. For example, in some implementations, the plurality of techniques comprises a first technique having a first ranking (e.g., using a network address associated with the request to perform a look-up, step 512) and a second technique having a second ranking that is lower than the first ranking (e.g., using an Autonomous System Number (ASN) to perform a look-up, step 524). Implementing the plurality of techniques in accordance with the associated rankings includes implementing the first technique, and detecting whether the one or more characteristics of the first network carrier were determined by implementing the first technique (e.g., detecting whether a result was returned from a look-up, verifying accuracy of a result returned from a look-up, etc.). In accordance with detecting that the one or more characteristics were not determined by implementing the first technique (and/or one or more other techniques) (e.g., detecting that look-up returned a null result), implementing the second technique to obtain the one or more characteristics of the first network carrier. In accordance with detecting that the one or more characteristics were determined by implementing the first technique (e.g., detecting that look-up returned a result, and optionally determining that the returned result is valid), foregoing implementation of the second technique (and/or one or more other techniques).

In some embodiments, two or more of the plurality of characteristic-determination techniques are combined to determine characteristics of a network carrier. In this way, results from each of the plurality of characteristic-determination techniques are compared (i.e., combined) to determine the network carrier. In some embodiments, each of the plurality of characteristic-determination techniques is assigned a weight (e.g., a degree of importance). Accordingly, a determination made by one of the plurality of characteristic-determination techniques will carry more weight versus a determination made by another of the plurality of characteristic-determination techniques. In some embodiments, the weights are assigned in a predetermined way. In some embodiments, the weights are assigned (or alternatively, updated) based on performance of the plurality of characteristic-determination techniques over time.

Referring now to FIG. 5C, the server system 140 performs at least one operation of a plurality of operations. The plurality of operations includes storing (528) the determined one or more characteristics of the first network carrier in association with the first user device in a first data structure. The first data structure specifies, for a plurality of user devices including the first user device, at least one of an identity of an associated network carrier and a network type of the associated network carrier (e.g., aggregate data structure 314, FIG. 3).

In some embodiments, the server system 140 determines (526) that the one or more characteristics of the first network carrier are at least partially inconsistent with information for the first user device provided by the first network carrier (e.g., IP data structure 316 in FIG. 3, provided by an associated network carrier). In accordance with the determination, storing the determined one or more characteristics in the first data structure includes replacing (530) the information for the first user device provided by the first network carrier with the determined one or more characteristics.

The plurality of operations also includes providing (532) access to the requested content, wherein the requested content includes content that is customized based on the determined one or more characteristics of the first network carrier. In other words, the content provided in response to the request is based on characteristics of a network carrier (e.g., network carrier identity, network type, associated geographical location, etc.) through which the request is received. Providing access to the requested content may include the server system 140 itself providing the requested content (e.g., providing access to content, services, and/or features hosted by the server system 140 or an associated system). Additionally and/or alternatively, providing access to the requested content may include the server system 140 linking or re-directing the requesting user device to another device or system (e.g., a third-party system, such as web server 150, that hosts the requested content, services, and/or features, FIG. 3).

In some embodiments, the content that is customized includes (534) content provided to subscribers of the first network carrier that is at least partially distinct from content provided to subscribers of a second network carrier. For example, in some implementations, the content that is customized includes at least one advertisement provided to subscribers of the first network carrier but not to subscribers of the second network carrier. In some implementations, the content that is customized includes a user-interface element provided for display to subscribers of the first network carrier but not to subscribers of the second network carrier (e.g., text, images, video, affordances, links, calls-to-action (CTA), and/or other graphical user interface elements displayed on a user device, and optionally with which a user may interact). In some embodiments, the customized content includes content provided in connection with accessing services available to subscribers of the first network carrier but not the second network carrier (e.g., access to features or functionalities of an online service that may be selectively enabled or disabled).

Although various implementations of the method 500 are described with respect to particular data structures (e.g., identifying the network address in the second data structure in step 512, identifying the one or more characteristics from the third data structure in step 516, etc.), any one of the disclosed data structures may be the same (or include at least some of the same information) as any other disclosed data structure (e.g., the second data structure is the third data structure, and thus the identifying in step 512 of FIG. 5A may be performed with respect to the third data structure, and the identifying in step 516 of FIG. 5A may be performed with respect to the second data structure). For example, a data structure may, for a plurality of user devices 102, specify associated Home Network Identifiers (HNIs) and Autonomous System Numbers (ASNs). In this example, characteristics of a network carrier may therefore be identified from a fourth data structure based on an HNI (step 522, FIG. 5B), while the same characteristics may also be identified from the fourth data structure based on an ASN (step 524, FIG. 5B).

For situations in which the systems discussed above collect information about users, the users may be provided with an opportunity to opt in/out of programs or features that may collect personal information (e.g., information about a user's preferences or a user's contributions to social content providers). In addition, in some embodiments, certain data may be anonymized in one or more ways before it is stored or used, so that personally identifiable information is removed. For example, a user's identity may be anonymized so that the personally identifiable information cannot be determined for or associated with the user, and so that user preferences or user interactions are generalized (for example, generalized based on user demographics) rather than associated with a particular user.

Although some of various drawings illustrate a number of logical stages in a particular order, stages which are not order dependent may be reordered and other stages may be combined or broken out. While some reordering or other groupings are specifically mentioned, others will be apparent to those of ordinary skill in the art, so the ordering and groupings presented herein are not an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A method, comprising:
at a server system having one or more processors and memory storing instructions for execution by the one or more processors:
receiving, from a first user device through a first network carrier, a request to access content;
determining one or more characteristics of the first network carrier from the request, including at least one of an identity of the first network carrier and a network type of the first network carrier, the determining comprising performing a look-up using information from the request; and
performing at least one of:
storing the determined one or more characteristics of the first network carrier in association with the first user device in a first data structure, the first data structure specifying, for a plurality of user devices including the first user device, at least one of an identity of an associated network carrier and a network type of the associated network carrier; and
providing access to the requested content, wherein the requested content includes content that is customized based on the determined one or more characteristics of the first network carrier.

2. The method of claim 1, wherein:
the information from the request includes a network address associated with the request, and
performing the look-up comprises identifying the network address in a second data structure provided by a first network carrier, the second data structure specifying a plurality of network addresses associated with the first network carrier.

3. The method of claim 1, wherein:
the information from the request includes identifying information stored in a subscriber identity module (SIM) of the first user device, and
performing the look-up comprises identifying, based on the identifying information, the one or more characteristics of the first network carrier from a third data structure, the third data structure specifying, for respective identifying information stored in SIMs of a plurality of user devices, one or more respective characteristics of associated network carriers.

4. The method of claim 3, wherein the identifying information stored in the SIM of the first user device includes at least one of:
a subscriber identity within a network of the first network carrier, wherein the subscriber identity is associated with the first user device, and
a device identifier uniquely associated with the first user device.

5. The method of claim 1, wherein:
the information from the request includes a Home Network Identifier (HNI), and
performing the look-up comprises identifying, based on the HNI, the one or more characteristics of the first network carrier from a fourth data structure, the fourth data structure specifying, for multiple HNIs, one or more respective characteristics of associated network carriers.

6. The method of claim 1, wherein:
the information from the request includes information specifying a Mobile Network Code (MNC) and a Mobile Country Code (MCC), and
performing the look-up comprises identifying, based on the MNC and MCC, the one or more characteristics of the first network carrier from a fifth data structure, the fifth data structure specifying, for multiple sets of MNCs and MCCs, one or more respective characteristics of associated network carriers.

7. The method of claim 1, wherein:
the information from the request includes an Autonomous System Number (ASN), and
performing the look-up comprises identifying, based on the ASN, the one or more characteristics of the first network carrier from a sixth data structure, the sixth data structure specifying, for a plurality of ASNs, one or more respective characteristics of associated network carriers.

8. The method of claim 1, wherein receiving the request comprises receiving the request from an application on the first user device that is associated with a service provided by the server system.

9. The method of claim 1, wherein receiving the request comprises receiving the request from an application on the first user device that is not associated with a service provided by the server system.

10. The method of claim 1, wherein:
the performing comprises providing access to the requested content including the content that is customized; and
the content that is customized includes content provided to subscribers of the first network carrier that is at least partially distinct from content provided to subscribers of a second network carrier.

11. The method of claim 10, wherein the content that is customized includes at least one advertisement provided to subscribers of the first network carrier but not to subscribers of the second network carrier.

12. The method of claim 10, wherein the content that is customized includes a user-interface element provided for display to subscribers of the first network carrier but not to subscribers of the second network carrier.

13. The method of claim 10, wherein the customized content includes content provided in connection with accessing services available to subscribers of the first network carrier but not the second network carrier.

14. The method of claim 1, wherein the request to access content is a current request, and determining the one or more characteristics of the first network carrier comprises:
determining that the information from the request is further associated with one or more characteristics of a second network carrier;
determining that one or more previous requests to access content received from the first user device through the first network carrier satisfy a threshold; and
in response to determining that the one or more previous requests satisfy the predefined threshold, associating the current request to access content with the one or more characteristics of the first network carrier.

15. The method of claim 1, wherein:
the performing comprises the storing;
the method further comprises determining that the one or more characteristics of the first network carrier are at least partially inconsistent with information for the first user device provided by the first network carrier; and
the storing comprises replacing the information for the first user device provided by the first network carrier with the determined one or more characteristics.

16. The method of claim 1, wherein:
determining the one or more characteristics comprises implementing a plurality of characteristic-determination techniques, wherein the implementing comprises performing a respective look-up using information from the request for each of the plurality of techniques; and
the performing comprises the storing, wherein the storing comprises associating the first user device with:
the respective information used to implement each of the plurality of techniques; and
the one or more determined characteristics.

17. The method of claim 16, wherein:
each of the plurality of characteristic-determination techniques has a respective ranking; and
implementing the plurality of techniques is performed in accordance with the rankings.

18. The method of claim 17, wherein the plurality of techniques comprises a first technique having a first ranking and a second technique having a second ranking that is lower than the first ranking, and implementing the plurality of techniques in accordance with the associated rankings comprises:
implementing the first technique;
detecting whether the one or more characteristics of the first network carrier were determined by implementing the first technique;
in accordance with detecting that the one or more characteristics were not determined by implementing the first technique, implementing the second technique to obtain the one or more characteristics of the first network carrier; and
in accordance with detecting that the one or more characteristics were determined by implementing the first technique, foregoing implementation of the second technique.

19. A server system, comprising:
a processor; and
memory storing one or more programs for execution by the processor, the one or more programs including instructions for:
receiving, from a first user device through a first network carrier, a request to access content;
determining one or more characteristics of the first network carrier from the request, including at least one of an identity of the first network carrier and a network type of the first network carrier, the determining comprising performing a look-up using information from the request; and
performing at least one of:
storing the determined one or more characteristics of the first network carrier in association with the first user device in a first data structure, the first data structure specifying, for a plurality of user devices including the first user device, at least one of an identity of an associated network carrier and a network type of the associated network carrier; and
providing access to the requested content, wherein the requested content includes content that is customized based on the determined one or more characteristics of the first network carrier.

20. A non-transitory computer-readable storage medium storing one or more programs for execution by one or more processors, the one or more programs including instructions for:
receiving, from a first user device through a first network carrier, a request to access content;
determining one or more characteristics of the first network carrier from the request, including at least one of an identity of the first network carrier and a network type of the first network carrier, the determining comprising performing a look-up using information from the request; and
performing at least one of:
storing the determined one or more characteristics of the first network carrier in association with the first user device in a first data structure, the first data structure specifying, for a plurality of user devices including the first user device, at least one of an identity of an associated network carrier and a network type of the associated network carrier; and
providing access to the requested content, wherein the requested content includes content that is customized based on the determined one or more characteristics of the first network carrier.
